(19) United States
(12) Patent Application Publication
(10) Pub. No.: US 2007/0226412 A1
(43) Pub. Date: Sep. 27, 2007

(54) Storage device, controller for storage device, and storage device control method

(75) Inventors: Harumi Morino, Kanagawa (JP); Jun Kitahara, Kanagawa (JP); Mariko Kasai, Kanagawa (JP); Yoshiju Watanabe, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., Amsterdam (NL)

(21) Appl. No.: 11/707,740

(22) Filed: Feb. 15, 2007

(30) Foreign Application Priority Data
Feb. 16, 2006 (JP) 2006-039107

(51) Int. Cl. G06F 13/00

(52) U.S. Cl. 711/113

(57) ABSTRACT

Embodiments in accordance with the present invention relate to realizing content protection by enhancing data safety by detecting falsification of data stored in a storage device. A storage device in accordance with an embodiment of the present invention includes an HDA (Head Disk Assembly) and a controller, and a nonvolatile memory that is connected to the controller. When writing data on a hard disk from an external device, validity of access is authenticated. When the authentication is successful, a digest of the data to be written is generated by using a hush function. The generated digest is stored in the nonvolatile memory. When reading out data, a digest of the data to be read out is generated, and the digest stored in the nonvolatile memory is read out, followed by verification of whether or not the digests coincide with each other. Since there is a possibility of falsification in the case where the digests do not coincide with each other, the possibility of falsification is informed to the external device.

### CROSS-REFERENCE TO RELATED APPLICATION

The instant nonprovisional patent application claims priority to Japanese Patent Application 2006-039107, filed Feb. 16, 2006 and incorporated by reference in its entirety herein for all purposes.

### BACKGROUND OF THE INVENTION

In recent years, service for distributing contents such as a movie and music by way of communication means such as the internet and digital broadcasting has been provided. Since data handled in such system are digitalized and easily replicated, it is important to protect copyright of the contents. As one of means for the protection, a method of distributing encrypted contents has been proposed. With the method, the contents are encrypted by employing a common key encryption system, for example, and a decryption key for decrypting the encrypted contents is simultaneously created. Since it is impossible to read the encrypted contents without the decryption key, an unauthorized use of the contents is prevented by controlling information which is a pair of the decryption key and a use condition for the decryption key, thereby protecting rights of creators of the contents.

Also, a technology for detecting data falsification is disclosed in Patent Publication 1 (JP-A-2000-341632) indicated below. Hereinafter, the data falsification detection technology of Patent Publication 1 will be explained by using FIG. 10. FIG. 10 is a block diagram showing one example of a structure of a conventional image recording/reproducing apparatus which is disclosed in Patent Publication 1.

Recording operation is as follows. An image picked up by a camera 201 is digitalized for bandwidth compression by an image compression unit 210 so that the information is reduced. The compressed information is stored in a recording unit 214 (hard disk, optical disk, semiconductor memory, or the like) after generation of data for falsification detection for each frames, for example, by a falsification detection data generation unit A 211 and combination of the generated data with data compressed by a data combining unit 213.

Reproducing operation is performed in such a manner that data to be reproduced are searched and read out from the recording unit 214 to be inputted to a read-out data separation unit 215 whereby the compressed information and the data generated for the falsification detection are separated from each other. The compressed information is inputted to an image expansion unit 216 to be recovered to the original image. Simultaneously, the compressed information is inputted also to the falsification detection data generation unit B 212 to generate falsification detection data. At the same time, the falsification detection data generated by the falsification detection data generation unit B 212 and the falsification detection data separated by the data separation unit 215 are inputted to a falsification detection unit 217 to verify whether or not they coincide with each other, thereby judging whether or not the recorded data have been falsified. When it is judged that the data have been falsified, a command for stopping display is given to a display control unit 218 to stop image-output to a monitor 203. Thus, it is possible to allow reproduction of image only when the data have not been falsified.

In the case where the above-mentioned conventional technology is applied to data which change in accordance with contents use conditions (number of times of reproduction, reproduction time) or utilization (consumption) of a shopping point and credit information, it is conceivable that a malevolent person, for example, commits piracy of rewriting the shopping point and credit information by means of an attack (rollback attack) of abusively operating data by making a backup before use and restores the data after the use. Since the attack makes it unnecessary to cipher the encrypted data, it is relatively easy to realize the piracy only by copying the data and the data for falsification detection. Meanwhile, though a method of restricting unauthorized access by using a password is adopted to a hard disk device (magnetic disk device), such security function is realized on a circuit board, and an attack of accessing data by avoiding the security function by directly controlling a replace or an HDA (Head Disk Assembly) of the circuit board is conceivable. Therefore, it is difficult to effectively prevent the rollback attack.

### BRIEF SUMMARY OF THE INVENTION

Embodiments in accordance with the present invention are related to content protection by enhancing data safety by detecting falsification of data stored in a storage device such as a hard disk device.

In a storage device formed of an HDA (Head Disk Assembly) and a controller, a nonvolatile memory is connected to the controller. When writing data on a hard disk from an external device, validity of access is authenticated. When the authentication is successful, a digest of the data to be written is generated by using a hush function. The generated digest is stored in the nonvolatile memory. When reading out data, a digest of the data to be read out is generated, and the digest stored in the nonvolatile memory is read out, followed by verification of whether or not the digests coincide with each other. Since there is a possibility of falsification in the case where the digests do not coincide with each other, the possibility of falsification is informed to the external device.

For a more complete understanding of the present invention, reference is made to the following detailed description taken in conjunction with the accompanying drawings.

### BRIEF DESCRIPTION OF THE DRAWINGS

FIG. 1 is a block diagram showing a constitution of a storage device according to an embodiment of the present invention.

FIG. 2 is a block diagram showing a constitution of a storage device according to another embodiment of the present invention.

FIG. 3 is a sequence diagram showing authentication by using a certificate and sharing a session key according to an embodiment of the present invention.

FIG. 4 is a sequence diagram showing processing for generating a session key when writing data according to an embodiment of the present invention.

FIG. 5 is a sequence diagram showing processing for generating a session key when reading data according to an embodiment of the present invention.

FIG. 6 is a block diagram showing a constitution of a storage device according to an embodiment of the present invention.

FIG. 7 is a block diagram showing a constitution of a storage device according to another embodiment of the present invention.

FIG. 8 is a block diagram showing a constitution of a storage device according to an embodiment of the present invention.

FIG. 9 is a diagram showing a mechanism for generating a physical address of a nonvolatile memory by using an offset table in an address generation unit according to an embodiment of the present invention.

FIG. 10 is a block diagram showing one example of a structure of a conventional image recording/reproducing apparatus.

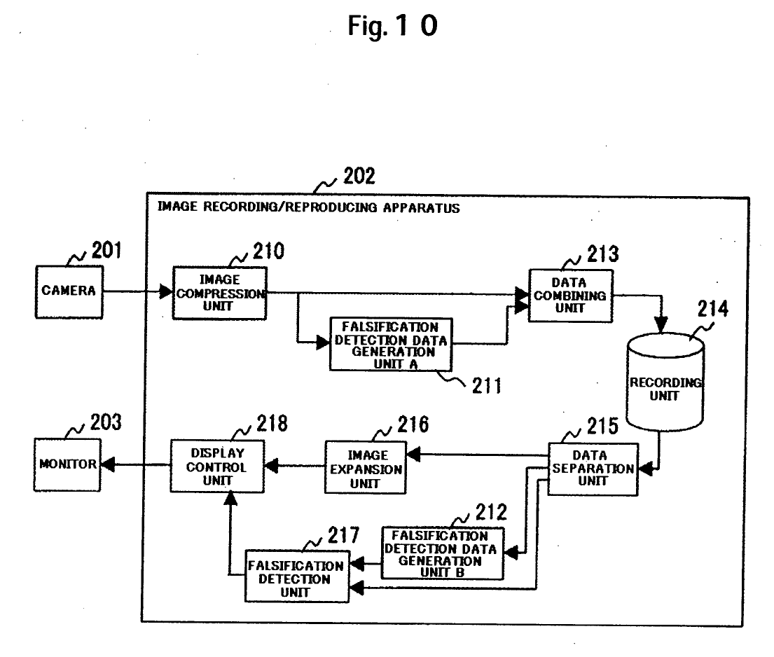

### DETAILED DESCRIPTION OF THE INVENTION

Embodiments of the present invention are directed to solving the above-described problems, and an object of an embodiment of the present invention is to provide a storage device capable of detecting falsification of data stored in the storage device such as a hard disk device to enhance safety of the data and to protect its contents.

Embodiments in accordance with the present invention relate to a storage device, a controller for the storage device, and a method for controlling the storage device. Particularly, embodiments of the present invention relate to a storage device which is used in an information processing system for storing data and programs and suitable for detecting presence/absence of falsification of stored data when the data requires copyright protection or data protection, a controller for the storage device, and a method for controlling the storage device.

The storage device according to an embodiment of the present invention comprises an HDA (Head Disk Assembly) unit including a magnetic disk such as a hard disk as a recording media and a controller. To the controller, a nonvolatile semiconductor memory such as a flash memory is connected.

In one embodiment of the present invention, in the case of writing data on the hard disk from an external device such as a PC, validity of access from the external device is authenticated first.

If the authentication is successful, a digest of data to be written is generated. For the generation of the digest, a unidirectional function called hush function which makes the original data “un-guessable” is used. As used herein, the digest means pseudo random numbers of a fixed length obtained by calculating the given original text (data) by using the unidirectional function.

The thus-generated digest is stored in the nonvolatile memory.

When reading out data from the hard disk from the external device, a digest of data to be read out is generated. Also, a digest stored in the nonvolatile memory is read out to verify whether or not the read out digest coincides with the digest of the data to be read out. Since the data stored in the hard disk could have been falsified in the case where the digests do not coincide with each other, the possibility of falsification is informed to the external device.

It is possible to enhance safety of data by encrypting data to be stored in the hard disk using a media encryption key unique to the hard disk device when storing the data and by decrypting the data when the data are read out.

Also, it is possible to further enhance the safety by sending data from the external device to the storage device after encrypting the data with the use of a session key which is used temporarily by the external device and the storage device.

Since the nonvolatile memory is expensive as compared to the hard disk from the standpoints of storage capacity and cost effectiveness, it is possible to generate the digest only for data that have a greater need for the falsification check.

Also, by mounting the nonvolatile memory as a tamper resistant module which is protected from piracy such as interception and falsification of data and programs, it is possible to enhance the safety of data.

Further, by mounting the nonvolatile memory, a processing unit, and an encryption processing unit involved in the digest as a tamper resistant modules, it is possible to further enhance the safety of data.

According an embodiment of the present invention, in the case where contents of which copyright needs to be protected are divided due to a disturbance caused during moving the contents, it is possible to continue the movement of the contents or to return the contents to a source of the contents by storing information specifying contents of the source, a media to which the contents are to be moved, and the contents and information indicating a state of the movement when moving the contents and by using the information for the movement or the returning of the contents. Therefore, a user does not have to remember how to deal with the divided contents as compared to the case wherein the contents are left divided, thereby greatly improving the user's convenience.

Also, in the case where contents are divided to be recorded on a media inside a terminal or a terminal connected via a network since it is impossible to continue the recording due to shortage of capacity of a storage media such as the HDD, it is possible to store information of relationship between the contents of the source and the contents of the destination. Therefore, it is possible to connect the divided contents when a space is spared in the capacity of the HDD by deleting other contents or the like, thereby greatly improving the user's convenience.

According to embodiments of the present invention, it is possible to provide a storage device capable of performing contents protection by enhancing safety of data by detecting falsification of data stored in a storage device such as a hard disk device.

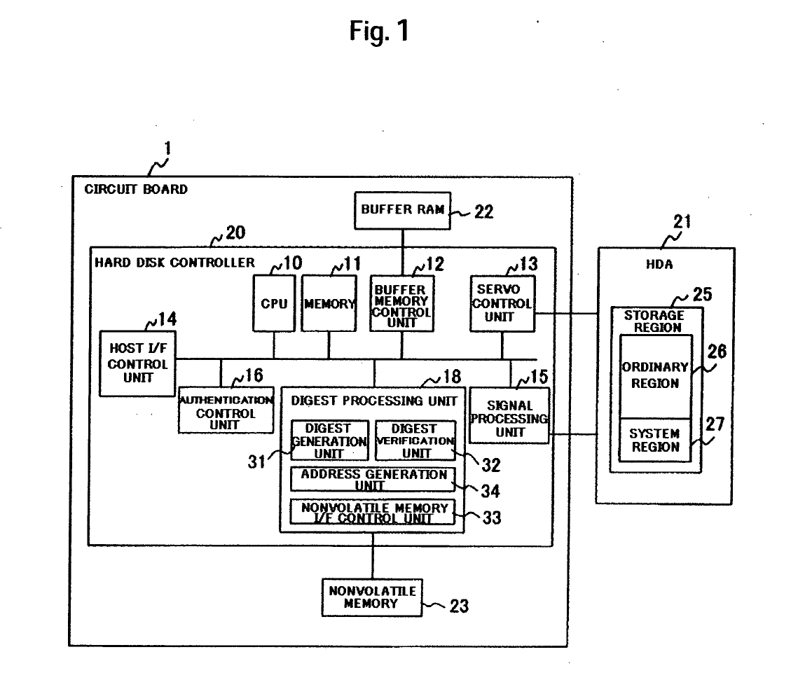

Hereinafter, embodiments according to the present invention will be described by using FIGS. 1 to 9.

### Embodiment 1

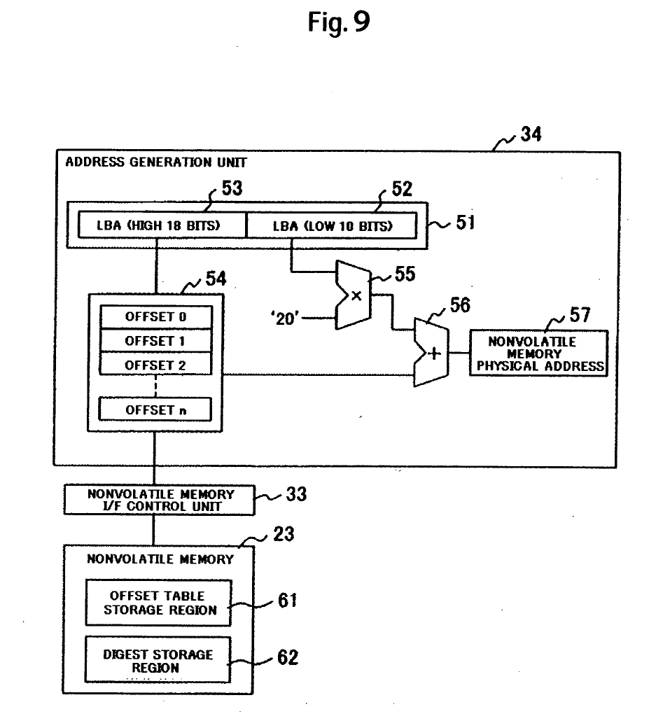

Hereinafter, a first embodiment according to the present invention will be described by using FIGS. 1 and 9.

A structure and operation of a storage device according to the first embodiment of this invention will now be described by using FIG. 1.

FIG. 1 is a block diagram showing a constitution of the storage device according to an embodiment of the present invention.

In a broad sense, the storage device of this embodiment is formed of a circuit board 1 of a hard disk and an HDA 21. In the HDA 21, a disk, a spindle motor, and a magnetic head are housed in a housing.

On the circuit board 1, a hard disk controller 20, a buffer RAM 22, and a nonvolatile memory 23 are mounted. The buffer RAM 22 is a volatile work memory. The nonvolatile memory 23 is a semiconductor memory capable of retaining stored contents after the power is turned off and used for storing digest data. Specifically, the nonvolatile memory 23 may be a FLASH memory or the like.

In this specification, the hard disk controller 20 is described as one into which a function of controlling the hard disk is integrated, but a part of the function of the hard disk controller may be mounted on the circuit board 1 as an external component part.

The hard disk controller 20 has a control CPU 20, a memory 11 for storing a control program and the like, a buffer control unit 12, a servo control unit 13, a host I/F control unit 14, a signal processing unit 15, an authentication control unit 16, and a digest processing unit 18.

The buffer control unit 12 is a part for performing control for temporarily storing on the buffer RAM 22 data read out from the HDA 21 and data to be written. The servo control unit 13 is a part for controlling the spindle motor of the HDA 21 by servo control. The I/F control unit 14 is a part for performing I/F with a host. The signal processing unit 15 is a part for performing modulation and demodulation as well as error correction of a signal when writing to and reading out from the HDA 21. The authentication control unit 16 is a part for controlling authentication when accessing the data stored in the HDA 21. The digest processing unit 18 is a part for performing digest generation and verification for the data to be written or read out.

The digest processing unit 18 has a digest generation unit 31, an address generation unit 34, a nonvolatile memory I/F control unit 33, and a digest verification unit 32.

The digest generation unit 31 is a part for generating a digest of data to be written. The address generation unit 34 is a part for generating an address of the nonvolatile memory 23 when storing or reading out the digest. The nonvolatile memory I/F control unit 33 is a part for controlling an I/F of the nonvolatile memory. The digest verification unit 32 is a part for verifying whether or not falsification has been made by generating a digest from read-out data and comparing the digest with the digest stored in the nonvolatile memory 23.

Hereinafter, operations performed for data writing and data reading of the storage device of this embodiment will be described.

The writing operation of this embodiment will now be described.

When it is possible to freely access data on a hard disk, data backup or data restore is easily realized, thereby making it possible to accomplish the above-described roll back attack. Therefore, authentication is firstly performed between the host of the external device and the hard disk.

In order to authenticate an access entity, authentication using an user ID and a password is performed when the access entity is a user; authentication using a license number and a serial number of a software is performed when the access entity is application software; and authentication using a MAC address, serial number of an appliance, and the like is performed when the access entity is an external device.

In the authentication using a password example, the password is inputted from the host via the host I/F control unit 14 to the hard disk controller 20, and the CPU 10 inputs the password to the authentication control unit 16. Then, a predetermined password is read out from a system region 27 which is inaccessible from the host of the HDA 21 to be inputted to the authentication control unit 16. The system region 27 is inaccessible from the host for enhancing the safety.

In the case where an arithmetic such as an encryption arithmetic is provided on the predetermined password, the authentication control unit 16 decrypts the encryption and compares the decrypted password with the password inputted from the host. In the case where the passwords do not coincide with each other, the authentication control unit 16 does not allow access to data stored in the hard disk. In the case where only the falsification is in question, it is possible to restrict only the data writing access by the authentication. In such case, since it is possible to freely read data, it is possible to browse the data freely.

In addition to the authentication performed once before the start of access, another authentication may be performed in the case where no access is made during a certain period of time.

Since the writing access is enabled when the authentication is successful, via the host I/F control unit 14, the data to be written and an address (logical block address: LBA) are transferred to the buffer memory control unit 12 via the CPU 10 or by DMA transfer to be temporarily stored in the buffer RAM 22. When access to the HDA 21 is enabled, the data to be written are read out from the buffer memory 22 and subjected to CRC processing and modulation in the signal processing unit 15, so that the data are written at a position indicated by the assigned LBA in an ordinary region 26 inside a storage region 25 of the HDA 21.

The data to be written and the LBA are transferred from the buffer RAM 22 to the digest processing unit 18 via the CPU 10 or by the DMA transfer. In the digest processing unit 18, the data are processed by the unit of a sector which is a minimum unit of access of the hard disk. As to the number of bytes for one sector, 512 bytes are generally used for one sector. Of course, numbers other than 512 are acceptable without problem, and, in view of access efficiency, 4 K bytes may be used for one sector.

In the digest processing unit 18, data for one sector are inputted to the digest generation unit 31 to generate a digest. For the digest, it is possible to use a unidirectional function called hash function which makes it difficult to guess the original data from the standpoint of security. Examples of the hash function include SHA-1, SHA-256, MD5, and the like. For example, with the SHA-1, an output is fixed to 20 bytes irrelevant from the number of inputted data. Also, since an algorithm of the hash function such as the SHA-1 is open to public, the hash function may be used by adding information unique to the hard disk to the data. With the use of the hash function, the digest is prevented from being easily forged.

In the address generation unit 33, an address of the nonvolatile memory storing the digest (an initial address of an area having a length of the digest) is generated based on the LBA transferred together with the data. For example, the address of the nonvolatile memory is calculated from Equation 1 shown below. This address may be a logical address or a physical address.
Address=LBA×(digest length)+offset (Equation 1)

Since output of the hash function is fixed, it is possible to calculate the address for storing the digest uniquely from the LBA by fixing the offset. With such address, it is possible to relate the data and the digest to each other when the data and the digest are stored in different media. The digest and the address to be stored are inputted to the nonvolatile memory I/F control unit 33 to store the digest sequentially from the relevant address of the nonvolatile memory 23. Inconsistency can occur since the digests and the data are stored in different media. Therefore, in order to confirm whether or not the data are written in the nonvolatile memory 23 without fail, the digests may be read out from the nonvolatile memory 23 to confirm whether or not they are stored normally. Since the data on the buffer RAM 22 are no longer necessary at this time point, the data stored in the buffer RAM 22 and the LBA are invalidated to release the region of the buffer RAM.

When the data and the digests are stored normally, completion of the writing processing is informed to the host via the host I/F control unit 14. When an error occurs in the series of the writing process steps, the error is informed to the host via the host I/F control unit 14. Also, though the example of sequentially performing the data writing and the digest writing has been described in the foregoing, it is possible to perform the operations in parallel.

Though the nonvolatile memory 23 is connected to the outside of the hard disk controller 20 in this embodiment, in view of an attack to the digest, it is possible to increase strength of security by incorporating the nonvolatile memory 23 into the hard disk controller 20.

The reading operation of this embodiment will now be described.

In the case of reading out data, a read command is informed from the host to the hard disk via the host I/F control unit 14. An LBA indicating the position of reading is also transferred as a parameter. The CPU 10 judges whether or not the data of the assigned LBA is cached in the buffer RAM 22 and, when the data have not been cached, reads out the data of the assigned LBA from the HDA 21 by controlling the servo control unit 14 and the signal processing unit 15 to store the data in the buffer RAM 22 together with the LBA. The LBA and the data are read out from the buffer RAM 22 via the buffer memory control unit 12 to be transferred to the digest processing unit 18.

In the digest processing unit 18, a digest is generated in the digest generation unit 31 from the data read out from the HDA 21. Then, the LBA is inputted to the address generation unit 34 to calculate, by using Equation 1, an address of the nonvolatile memory 23 in which the digest has been stored by data writing. The address is inputted to the nonvolatile memory I/F control unit 33 to read out the digest from the relevant address.

The digest read out from the nonvolatile memory 23 and the digest generated by the digest generation unit 31 are inputted to the digest verification unit 32 to compare the digests by the digest verification unit 32. As a result of the comparison, it is judged that data are not falsified when the digests coincide with each other, and the data read out from the HDA 21 are transferred to the host via the host I/F control unit 14. When the digests do not coincide with each other, it is judged that the data could have been falsified, and the possibility of falsification is informed to the host via the host I/F control unit 14. In this case, the data may or may not be transferred to the host.

Also, since the digest can be abusively operated, it is necessary to prevent access to the nonvolatile memory 23 via the host I/F control unit 14.

Further, though the digest processing and the authentication processing are described as function blocks in the foregoing, the digest processing and authentication processing may be performed by using the CPU 10 and software.

With such constitution, it is ensured that the digest stored in the nonvolatile memory 23 is altered only when data are written after succeeding in the authentication. Therefore, when the circuit board is replaced, it is possible to detect whether or not the data have been falsified by directly controlling the HDA by removing the circuit board, thereby making it possible to prevent abuse of the contents and a fraud by way of tampering of data.

Hereinafter, another example for obtaining, from the LBA address, the address of the nonvolatile memory storing the digest will be described by using FIG. 9.

FIG. 9 is a diagram showing a mechanism for generating a physical address of the nonvolatile memory by using an offset table in the address generation unit.

An LBA register 51 is a register for storing an LBA. The LBA is logically divided into LBA high 18 bits 53 and LBA low 10 bits 52 as shown in FIG. 9. The offset table 54 is a table having plural offsets of the physical address storing the digest.

The physical address of the nonvolatile memory is obtained by multiplying the LBA low 10 bits 52 by a constant in a multiplier 55 and then adding the obtained value to an offset value of the offset table 54 in an accumulator 56 to be stored in a nonvolatile memory physical address register 57.

The nonvolatile memory 23 has an offset table storage region 61 and a digest storage region 62. The offset table storage region 61 is used for storing the value of the offset table inside the nonvolatile memory, and the digest storage region 62 is used for storing the digest inside the nonvolatile memory.

When the hard disk is started, the address generation unit 34 reads data of the offset of the physical address for storing the digest from the offset table storage region 61 inside the nonvolatile memory 18 into the offset table 54 via the nonvolatile memory I/F control unit 33.

When an LBA (e.g., an LBA comprising 28 bits) is set in the LBA register 51, the high LBA 18 bits 53 are inputted to the offset table 54 to output a corresponding offset which is inputted to the accumulator 56. In this case, an offset 0 is outputted when the LBA high 18 bits 53 are ‘00000h’, and an offset 1 is outputted when the LBA high 18 bits 53 are ‘00001h’, for example. Then, the LBA low 10 bits 52 are inputted to the multiplier 55 to be multiplied by 20. As used herein, ‘20’ is the length of the digest when the SHA-1 is used. The output from the multiplier 55 is inputted to the accumulator 56. In the accumulator 56, the offset outputted from the offset table 54 is added to the value obtained by the calculation by the multiplier 55 to be stored in the nonvolatile memory address register 57. Thus, it is possible to uniquely calculate the physical address (the initial physical address of each of the areas each having 20 bytes for storing the digest provided on the nonvolatile memory 23) of the nonvolatile memory 23 for storing the digest based on the LBA.

Also, since the number of times of writings is limited in the FLASH device, the region for writing digest becomes un-writable when data writing is performed on a specific region. With such constitution, in the case where a FLASH device is used as the nonvolatile memory, for example, it is possible to extend the life of the FLASH device by changing the position for storing digest by assigning an address of a vacant region to an offset in the relevant offset table storage region when the region for writing digest becomes un-writable.

Though the data of offset are temporarily read into the address generation unit in the foregoing example, the constitution may be so changed that the offset is read out from the offset table storage region of the nonvolatile memory when the LBA is set. Also, though the LBA which is the logical address is used as the address of the HDA, an address for storing the digest may be generated by using the physical address of the HDA.

### Embodiment 2

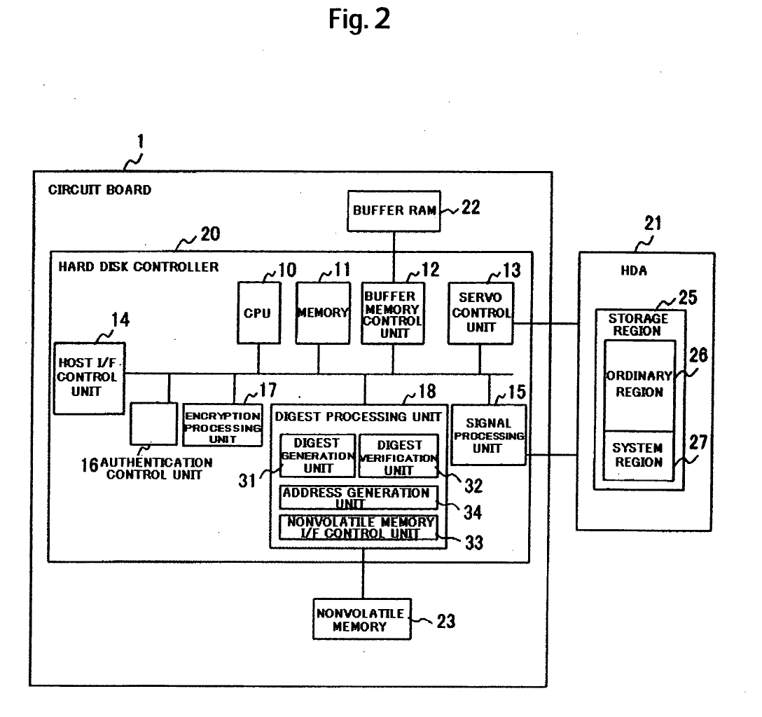

Hereinafter, a constitution and operation of a storage device according to another embodiment of the present invention will be described by using FIGS. 2 to 5.

FIG. 2 is a block diagram showing the constitution of the storage device according to another embodiment of this invention.

This embodiment is one example of encrypting data between a host and the storage device and storing the encrypted data also in a recording media.

As shown in FIG. 2, the storage device of this embodiment has an encryption processing unit 17 and performs encryption and decryption of data.

The writing operation of this embodiment will now be described.

When it is possible to freely access data on a hard disk, data backup or data restore is easily realized, thereby making it possible to accomplish the above-described roll back attack. Therefore, authentication is firstly performed between the host and the hard disk, so that the host and the hard disk share a session key for performing data encryption on a host I/F. The session key is a temporary key which is newly generated for every authentication and disappears when the session is terminated. The sharing of the session key will be described later in this specification.

When the authentication is successful to enable the session key to be shared, the CPU 10 sets the session key in the encryption processing unit 17. Also, the CPU 10 reads out a media encryption key for encrypting data when storing the data in the storage region 25 of the HDA 21 from the nonvolatile memory 23 to set the media encryption key in the encryption processing unit 17.

The media encryption key may be encrypted since there is a possibility that the media encryption key is intercepted when it is read out from the nonvolatile memory 23. In the case where the media encryption key has been encrypted, the encrypted media encryption key is decrypted to be set in the encryption processing unit.

When the authentication is successful, writing access is enabled. Since the session key is shared by the host and the hard disk, data to be written are encrypted in the host by using the session key, and then the encrypted data and information of LBA are transferred to the hard disk via the host I/F control unit 14. The information of LBA which is an address for storing the data may also be encrypted.

The encrypted data and the LBA are transferred to the buffer memory control unit 12 by the CPU 10 or the DMA transfer to be temporarily stored in the buffer RAM 22. When access to the HDA 21 is enabled, the data to be written are read out from the buffer RAM 22 to be transferred to the encryption processing unit 17. In the encryption processing unit 17, the encrypted data encrypted by the session key are firstly decrypted by using the session key, and then the data are encrypted again by using the media encryption key. The thus-encrypted data are transferred to the signal processing unit 15 to be subjected to CRC processing and modulation in the signal processing unit 15, so that the data are written in the position indicated by the assigned LBA of the ordinary region 26 inside the storage region 25 of the HDA 21.

Simultaneously with the above processing, the data encrypted by the media encryption key are transferred to the digest processing unit 18. In the digest processing unit 18, the data are processed by the unit of a sector which is a minimum unit for accessing the hard disk. The encrypted data for one sector are firstly inputted to the digest generation unit 31 to generate a digest. Then, an address of the nonvolatile memory for storing the digest is generated in the address generation unit 33 based on the LBA transferred together with the encrypted data. The address for storing the digest is inputted to the nonvolatile memory I/F control unit 33 to store the digests sequentially from the relevant addresses of the nonvolatile memory 23. Since the data on the buffer RAM 22 are no longer necessary at this time point, the data and the LBA stored in the buffer RAM 22 are invalidated to release the region in the buffer RAM.

As described in the foregoing, when the encrypted data and the digests are normally stored, the completion writing is informed to the host via the host I/F control unit 14. Also, when an error occurs in the series of the writing process steps, the error is informed to the host via the host I/F control unit 14.

The reading operation of this embodiment will now be described.

Since the session key is used for encrypting the data on the host I/F, authentication is necessary in the case of reading out data, too. In the case where the session key is not shared, authentication is performed to share the session key between the host and the hard disk, so that the session key and the media encryption key are set in the encryption processing unit 17.

In the case of the data reading, a read command is informed from the host to the hard disk via the host I/F control unit 14. Simultaneously, an LBA indicating the position of reading is also transferred as a parameter. The CPU 10 judges whether or not the data (data encrypted by the media encryption key) of the assigned LBA are cached in the buffer RAM 22 and, when the data have not been cached, reads out the encrypted data of the assigned LBA from the HDA 21 by controlling the servo control unit 14 and the signal processing unit 15 to store the data in the buffer RAM 22 together with the LBA. The LBA and the encrypted data are read out from the buffer RAM 22 via the buffer memory control unit 12, so that the LBA and the data are transferred to the digest processing unit 18.

In the digest processing unit 18, a digest is generated in the digest generation unit 31 from the encrypted data read out from the HDA 21. Then, the LBA is inputted to the address generation unit 34 to calculate, by using Equation 1 described in Embodiment 1, an address of the nonvolatile memory 23 in which the digest is stored when the data are written. The address is inputted to the nonvolatile memory I/F control unit 33 to read out the digest from the relevant address. The digest read out from the nonvolatile memory 23 and the digest generated by the digest generation unit 31 are inputted to the digest verification unit 32 to compare the digests by the digest verification unit 32. As a result of the comparison, it is judged that data are not falsified when the digests coincide with each other, so that the encrypted data read out from the HDA 21 are transferred to the encryption processing unit 17 to decrypt the encrypted data by using the media encryption key. Then, the data decrypted by the media encryption key are encrypted again by using the session key to be transferred to the host via the host I/F control unit 14. When the digests do not coincide with each other, it is judged that the data could have been falsified, and the possibility of falsification is informed to the host via the host I/F control unit 14.

With such constitution, since the data are encrypted, the safety is enhanced despite the data and the media such as HDA on the transfer path between the host I/F and the storage device are analyzed. For example, in the case of storing a contents key used for encrypting contents in contents distribution and a license including use conditions, the storage device is suitably used. Particularly, since the contents key is the information that should not be known by users, the above-described encryption is useful.

Though the digests are generated and verification is performed for the data encrypted by the media encryption key, it is also possible to generate and verify the digests for the data that are not encrypted. In such case, data are written in such a manner that: data encrypted by the session key are decrypted by using the session key in the encryption processing unit; digests are generated and stored for the decrypted data; and the digests are encrypted again by using the media encryption key in the encryption processing unit to be stored in the HDA. Data are read out in such a manner that: the encrypted data read out from the HDA are decrypted in the encryption processing unit by using the media encryption key; digests are verified; and, when no falsification is detected, the data are encrypted again by using the session key in the encryption processing unit to be transferred to the host.

Though both the encryption on the host I/F and the encryption for storing in media are performed in the example described above, the constitution may be so changed that either one of the encryptions is performed.

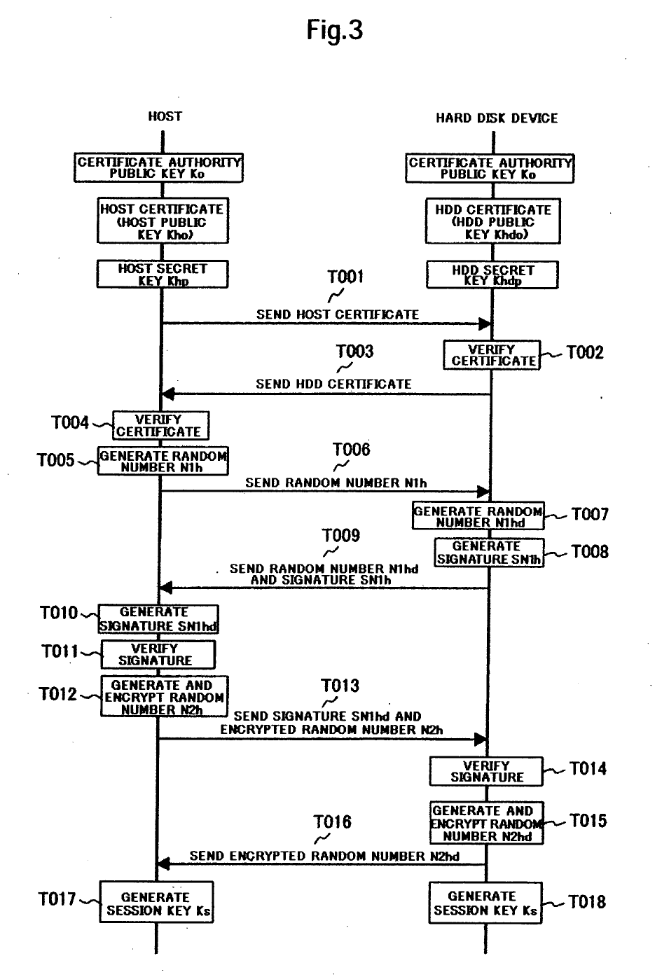

Hereinafter, one example of the authentication wherein the session key is shared will be described by using FIG. 3.

FIG. 3 is a sequence diagram showing authentication using a certificate and sharing the session key.

The hard disk device preliminary sets a public key Ko of a certificate authority, a certificate of the hard disk drive (HDD certificate including a public key and a signature for authentication of the hard disk), and a secret key of the hard disk (HDD secret key), which may be set when the hard disk was manufactured or by the user after purchasing the hard disk. In the host, the public key Ko of certificate authority, a host certificate (including a public key and a signature for authentication of the host), and a host secret key are preliminary set.

The host sends the host certificate to the hard disk device (T001). Then, the hard disk verifies the host certificate by verifying the signature using the certificate authority public key Ko to confirm that the host certificate is free from falsification and the certificate has been issued by the certificate authority (T002). The hard disk transfers the HDD certificate to the host (T003). The host verifies the HDD certificate by verifying the signature using the certificate authority public key Ko to confirm that the HDD certificate is free from falsification and the certificate has been issued by the certificate authority (T004). Also, IDs unique to respective certificates may be stored so that the authentication is enabled only when it is confirmed that the IDs are those preliminary registered in the host and the hard disk.

Then, a random number N1h is generated in the host (T005) to be transferred to the hard disk (T006). A random number N1hd is generated in the hard disk (T007) to generate a signature SN1h by using the HDD secret key for the transferred random number N1h (T008). The random number N1hd and the signature SN1h are transferred to the host (T009). In the host, a signature SN1hd is generated by using the host secret key for the transferred random number N1hd (T010).

The host verifies the signature SN1h by using the HDD public key Khdo included in the HDD certificate to confirm that the HDD has the secret key (T011). Then, the host generates a random number N2h and encrypts the random number N2h by using the HDD public key (T012) to send the signature SN1hd and the encrypted random umber N2h to the hard disk (T013). The hard disk verifies the signature SN1hd by using the host public key Kho included in the host certificate to confirm that the host has the secret key (T014). The above procedure enables the hard disk and the host to confirm that the secret keys included in the certificates of the hard disk and the host are valid.

The hard disk generates a random number N2hd and encrypts the random number N2hd by using the host public key (T015) to transfer the encrypted random number N2hd to the host (T016). The host decrypts the encrypted random number N2hd by using the host secret key to generate a session key by using N2h generated by the host and N2hd (T017). The hard disk decrypts the encrypted random number N2hd by using the HDD secret key to generate a session key by using N2hd generated by the hard disk, N2h, and an algorithm which is the same as that of the host (T018).

Since it is impossible to decrypt the data encrypted by using the public key without the secret key, and since it is impossible to decrypt the random number for generating the session key without the secret key even if the data on the host I/F are intercepted, it is possible to safely share the session key. Also, by encrypting data by using the session key shared as described above, it is possible to securely exchange data between the host and the hard disk.

Since data are generally written after being read out and updated, a replay attack wherein data encrypted by a session key are stored when the data are read out, and the stored encrypted data are written after the data are updated and written may occur when an identical session key is used for the writing and the reading. However, it is possible to prevent the replay attack by setting different values for the session key for writing and the session key for reading.

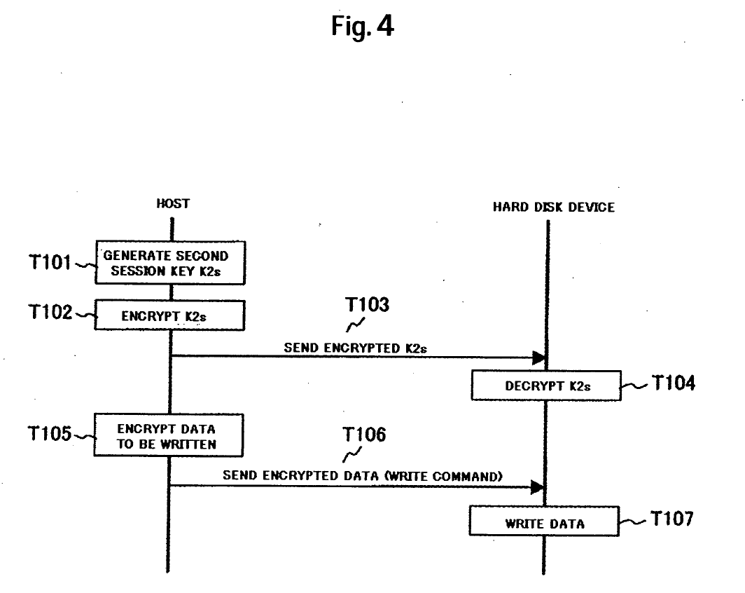

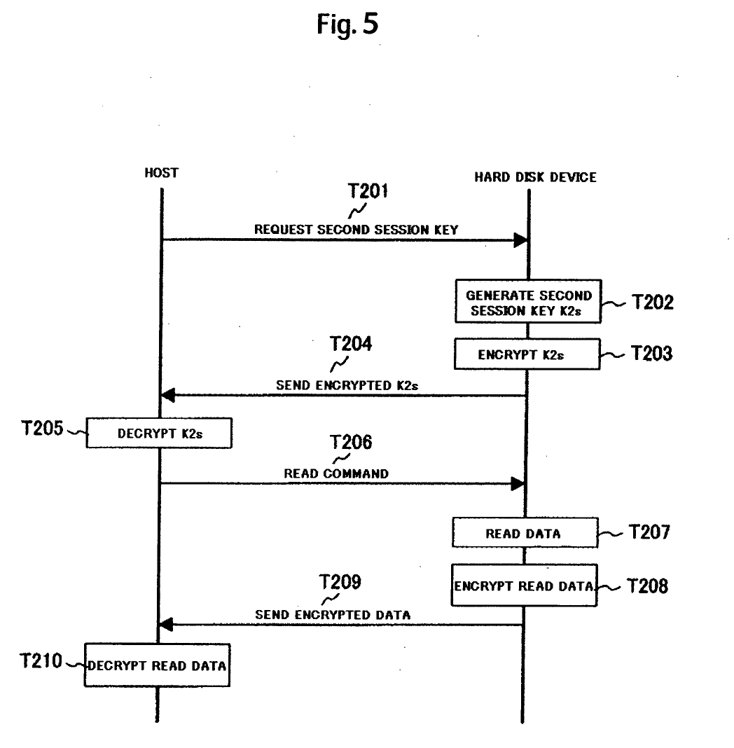

Hereinafter, a method for changing the session key for every data writing or data reading will be described by using FIGS. 4 and 5.

FIG. 4 is a sequence diagram showing processing for generating a session key when writing data.

FIG. 5 is a sequence diagram showing processing for generating a session key when reading data.

The method for verifying the certificates and the signatures of the host and the hard disk has been described in the foregoing, but overhead is increased when such processing is performed for every data writing and reading. Therefore, in order to reduce the overhead simultaneously with ensuring security, the session key is changed for every data writing and reading as described below.

The writing operation of this embodiment will now be described with reference to FIG. 4.

The session key Ks has already been shared by the processing shown in FIG. 3.

The host generates a second session key K2s to be used for data encryption by using a random number or the like (T101). The second session key K2s is then encrypted by using the session key Ks which has already been generated (T102) to be sent to the hard disk device (T103).

The hard disk device decrypts the received encrypted K2s by using the shared session key Ks (T104). The host encrypts data to be written by using the second session key K2s (T105) and sends the encrypted data (write command) to the hard disk (T106). The hard disk device decrypts the data by using K2s and generates a digest as described in the foregoing. The hard disk then stores the digest in the nonvolatile memory 23 and encrypts the data by using the media encryption key to write the data on a media such as the HDA 21 (T107).

Hereinafter, operation when reading will be described with reference to FIG. 5.

The host requests the hard disk device for a second session key (T201).

The hard disk device generates the second session key K2s by using a random number or the like (T202). The second session key K2s is encrypted by using the session key Ks (T203) to be sent to the host (T204).

The host decrypts the received encrypted K2s by using the shared session key Ks (T205). The host then requests the hard disk device for reading (206).

The hard disk device reads out encrypted data from the HDA 21 and verifies presence/absence of falsification. When the encrypted data are free from falsification, the hard disk device decrypts the encrypted data by using the media encryption key (T207) to encrypt the data by using the second session key K2s (T208). The hard disk then transfers the data encrypted by using K2s to the host (T209).

The host decrypts the read-out data by using the second session key K2s to use the data.

As described above, since the key for encrypting the data on the host I/F is changed for every access to the hard disk device, it is possible to more safely prevent the replay attack.

### Embodiment 3

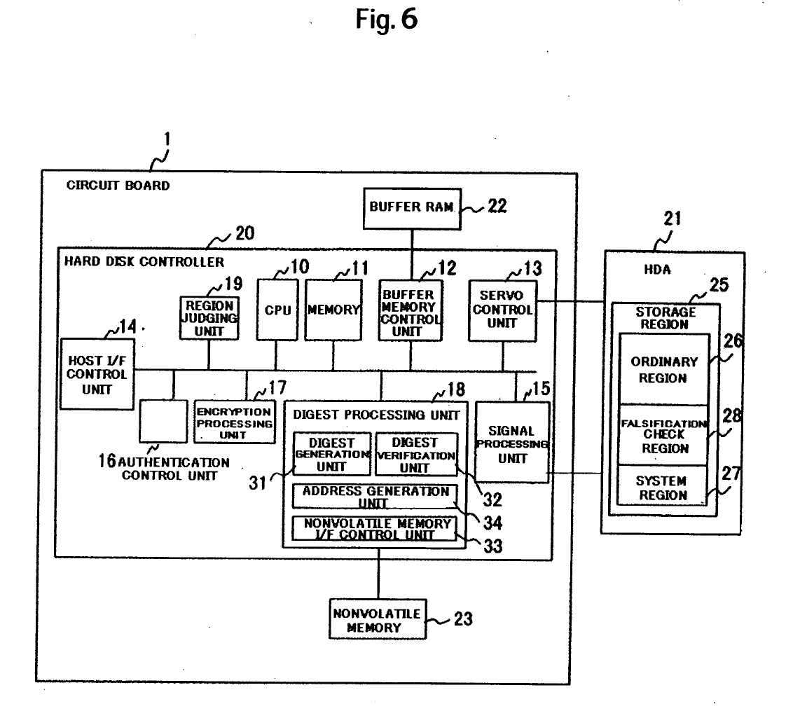

Hereinafter a constitution and operation of a storage device according to another embodiment of the present invention will be descried by using FIG. 6.

FIG. 6 is a block diagram showing the constitution of the storage device according to an embodiment of the present invention.

From the standpoints of storage capacity and cost effectiveness, the nonvolatile memory such as the FLASH memory is more expensive than the hard disk. Also, a compression ratio of SHA-1 is 1/25 per sector, which is not so expensive. Therefore, this embodiment is aimed for enhancing the effect with respect to the price by generating a digest only for a portion having a greater need for the falsification check.

As shown in FIG. 6, a storage region 28 of an HDA 21 of this embodiment is formed of an ordinary region 26, a falsification check region 28, and a system region 27. The ordinary region 26 is a region on a hard disk media for storing data for which falsification detection is not performed, and the falsification check region 28 is a region on the hard disk media for storing data for which the falsification detection is performed.

The falsification check region 28 is a storage region for information that particularly needs protection against falsification, such as license information, point information of a point system in which a point is added in accordance with purchase of merchandise/service, and information relating to electronic money.

A hard disk controller 20 has a region judging unit 19 for judging whether or not access from a host is for the region in which the falsification detection is performed.

In the case where the host accesses the hard disk, a write command or a read command is sent to the host I/F 14. The command includes an LBA indicating an address of the HDA 21 as a parameter. The CPU 10 sets the information of the LBA in the region judging unit 19. The region judging unit 19 retains a start LBA and an end LBA of the falsification check region 28 and judges whether or not the set LBA is in the range of start LBA≦LBA≦end LBA.

In the case of writing, when it is judged that the LBA of the data is the LBA in the falsification check region 28, the CPU 10 writes the data in the assigned LBA in the falsification check region 28 to generate digests in a digest processing unit 18, followed by storing the digests in a nonvolatile memory 23.

In the case of reading, when it is judged that the LBA of the data is the LBA in the falsification check region 28, the data are read out from the assigned LBA in the falsification check region 28 to confirm whether or not the data have been falsified by performing verification of digests in the digest processing unit 18. Then, the read-out data are transferred to the host.

On the other hand, when it is judged that the LBA is not the LBA in the falsification check region 28, and the LBA is the address within the ordinary region 26, at the time writing the data, the digest is generated and then the data is written to the ordinary region 26. Also, at the time reading the data, without performing verification of digest, the data is read-out from the ordinary region 26 to transfer to the host.

Though the LBA is used for judging whether or not the data are in the falsification check region 28 in the above-described example, the command may be altered when accessing the falsification check region 28. With such alteration, it is possible to judge whether the access is for the ordinary region 26 or for the falsification check region 28 by the command.

With the above constitution, it is possible to limit the region for falsification check. More specifically, it is also possible to limit the capacity of the nonvolatile memory for storing the digests, thereby making it possible to suppress the cost and mounting area for the nonvolatile memory. For example, in the case of a hard disk having a capacity of 500 GB, a capacity of 20 GB is required for a nonvolatile memory using SHA-1 for generating the digest by the unit of 512 bytes per sector, and, when a semiconductor memory such as a FLASH is used, a cost and a mounting area for the memory are considerably increased.

Since the digests are generated only for the data in the region for storing the information requiring the falsification check, it is possible to largely reduce the capacity of the nonvolatile memory.

### Embodiment 4

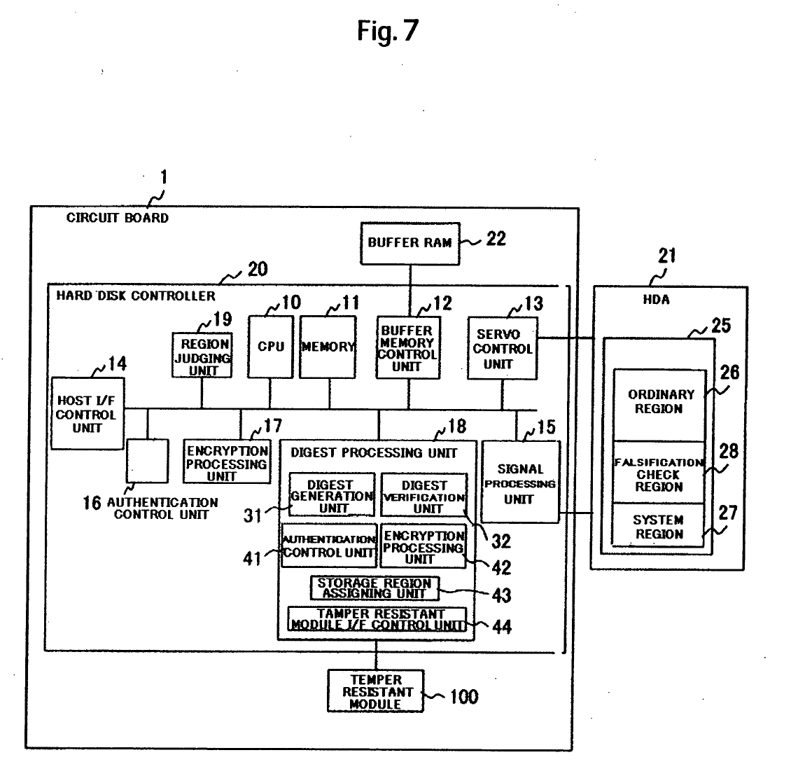

Hereinafter, a constitution and operation of a storage device according to another embodiment of the present invention will be described by using FIG. 7.

FIG. 7 is a block diagram showing the constitution of the storage device according to another embodiment of the present invention.

The storage device of this embodiment is capable of storing digests in a tamper resistant module. As shown in FIG. 7, the storage device of this embodiment has a tamper resistant module 100 connected to a digest processing unit 18 of a hard disk controller 20. The tamper resistant module 100 is a module having a resistance against external attacks on data stored inside.

The digest processing unit 18 has a storage region assigning unit 43 and a tamper resistant module I/F control unit 44 in an authentication control unit 41 and an encryption processing unit 42. The authentication control unit 41 is a part for performing authentication with the tamper resistant module 100. The encryption processing unit 42 is a part for encrypting/decrypting data when sending/receiving the data to/from the tamper resistant module 100. The storage region assigning unit 43 is a part for assigning a position inside a nonvolatile memory in the tamper resistant module 100. The tamper resistant module I/F control unit 44 is a part for controlling I/F with the tamper resistant module.

Hereinafter, operation for accessing the tamper resistant module will be described.

The tamper resistant module 100 is an IC card chip, for example, and incorporates a CPU and a nonvolatile memory. The tamper resistant module 100 is capable of so controlling as to prevent access to internal data when the access does not succeed in authentication and has a hardware level function of having its current control circuit and internal circuits covered with a metal mask. Therefore, the tamper resistant module 100 is a device having a resistance that is not analyzed easily by means of current analysis/voltage analysis by operation.

In the case of accessing the tamper resistant module, authentication similar to that between the hard disk device and the host described in Embodiment 2 is performed between the authentication control unit 41 and the tamper resistant module 100, and a session key is shared by the hard disk controller 20 and the tamper resistant module 100. The shared session key is set in the encryption processing unit 42.

In the case of storing a digest in the tamper resistant module 100, a digest generated by the digest generation unit 31 is encrypted in the encryption processing unit 42 by using the session key, and information specifying a position of the nonvolatile memory inside the tamper resistant module 100 is generated based on an address of an LBA in the storage region assigning unit 43. The digest encrypted by using the session key and the information specifying the position of the nonvolatile memory are sent to the tamper resistant module I/F 44 to be sent to the tamper resistant module 100.

The tamper resistant module 100 decrypts the encrypted digest by using the session key and generates a physical address of the incorporated nonvolatile memory based on the information specifying the position of the nonvolatile memory to store the digest in the address.

In the case of reading out the digest from the tamper resistant module 100, the information specifying the position of the nonvolatile memory inside the tamper resistant module 100 is generated based on the address of the LBA in the storage region assigning unit 43, and the information is sent to the tamper resistant module I/F 44 to request the tamper resistant module 100 for reading of the digest.

Then, the tamper resistant module 100 generates a physical address of the incorporated nonvolatile memory based on the information specifying the position of the nonvolatile memory and reads out the digest from the address. The tamper resistant module 100 then encrypts the digest by using the session key to send the encrypted digest to the tamper resistant module I/F 44.

Then, the hard disk controller 20 decrypts the encrypted digest by using the session key in the encryption processing unit 42, and the digest verification unit 32 compares the digest generated from the data read out from the HDA 21 with the decrypted digest to confirm whether or not there is falsification.

Also, since an accessing method of a nonvolatile memory such as a FLASH memory is open to public, an attack such as falsification on digest is conceivable in the case of storing a digest in such device. However, it is possible to make the falsification on digest difficult by performing the above-described processing as compared to storing a digest on the ordinary nonvolatile memory such as the FLASH memory, thereby making it possible to provide the storage device having higher security strength.

### Embodiment 5

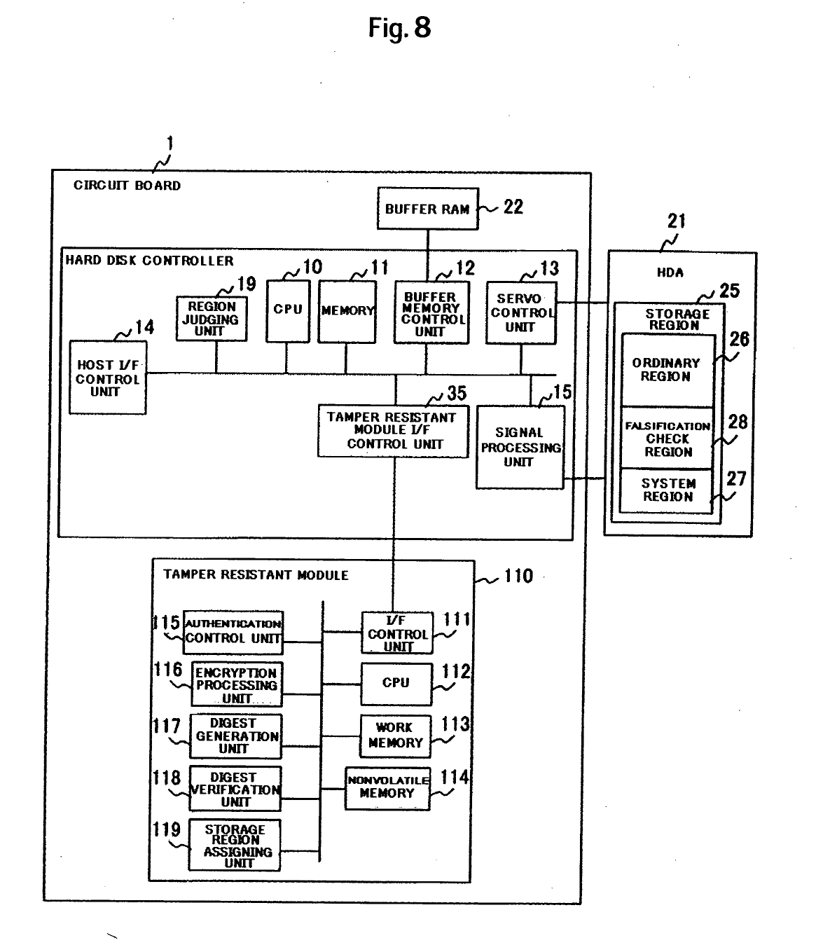

Hereinafter, a constitution and operation of a storage device according to another embodiment of the present invention will be described by using FIG. 8.

FIG. 8 is a block diagram showing the constitution of the storage device according to another embodiment of the present invention.

The storage device of this embodiment is capable of generating and verifying a digest inside a tamper resistant module. As shown in FIG. 8, the storage device of this embodiment has a tamper resistant module I/F control unit 35 in the hard disk controller 20, and a tamper resistant module 110 is connected to the tamper resistant module I/F control unit 35. The tamper resistant module I/F control unit is a part for performing I/F control with the tamper resistant module 110.

The tamper resistant module 110 has an I/F control unit 111, a CPU 112, a work memory 113, a nonvolatile memory 114, an authentication control unit 115, an encryption processing unit 116, a digest generation unit 117, a digest verification unit 118, and a storage region assigning unit 119.

The I/F control unit 111 is a part for performing control on I/F with the hard disk controller 20. The CPU 112 is a part for executing a program for performing control on function blocks, data processing, and handling in the tamper resistant module 110. The work memory 113 is a part for storing temporal data. The nonvolatile memory 114 is a part for storing programs and data, particularly, digests of data to be stored in the hard disk. The authentication control unit 115 is a part for performing control on authentication. The encryption processing unit 116 is a part for performing processing for encryption. The digest generation unit 117 is a part for generating digests. The digest verification unit 118 is a part for performing verification of the digests. The storage region assigning unit 119 is a part for generating from an LBA for storing the data an address of the nonvolatile memory for storing the digests.

The data writing operation of this embodiment will now be described.

In order to access the falsification check region 28, authentication is firstly performed between the host and the hard disk. Since the authentication relating to the access of hard disk is performed by the tamper resistant module 110, the host performs authentication with the authentication control unit 115 inside the tamper resistant module 110 via the host I/F control unit 14, the tamper resistant module I/F control unit 35, and the I/F control unit 111 of the tamper resistant module 110, and a session key is shared between the host and the tamper resistant module 110 when the authentication is successful. The shared session key is set in the encryption processing unit 116 by the CPU 112. The CPU 112 sets a media encryption key which is stored in the nonvolatile memory 114 to be used for storing data in the HDA 21 in the encryption processing unit 116.

When the authentication is successful, access is enabled. Since the session key is shared by the host and the hard disk, data to be written in the host are encrypted by using the session key in the encryption processing unit 116, and then the encrypted data and information of an LBA are transferred to the hard disk via the host I/F control unit 14.

The encrypted data and the LBA are transferred to the buffer memory control unit 12 by the CPU 10 or by the DMA transfer to be temporarily stored in the buffer RAM 22.

The data are read out from the buffer RAM 22 to be transferred to the tamper resistant module 110 via the tamper resistant module I/F control unit 35. The tamper resistant module 110 transfers the encrypted data to the encryption processing unit 116. The encrypted data that have been encrypted by using the session key are decrypted by using the session key and then the data are encrypted again by using the media encryption key in the encryption processing unit 116.

When the data are judged to be written in the falsification check region by the region judging unit 19 in the hard disk controller 20, the data encrypted by the media encryption key are transferred to the digest generation unit 117. The digest generation unit 117 generates a digest based on data for one sector of the encrypted data.

The storage region assigning unit 119 generates an address of the nonvolatile memory 114 for storing the digest based on the LBA transferred together with the data encrypted by the session key. Then, the digests and the addresses to be stored are sequentially stored in the nonvolatile memory 114 in accordance with the addresses.

Also, in the case of data of which a format is known in advance, such as a license including a contents key required for utilization of encrypted contents, the contents key may be stored in the nonvolatile memory 114 together with the digests by: fetching the contents key after decrypting the encrypted data by using the session key; replacing the data of the contents key by dummy data; and encrypting again the data by using the media encryption key.

Then, the data encrypted again by the media encryption key are transferred to the hard disk controller 20 via the I/F control unit 111. After that, the hard disk controller 20 transfers the data encrypted again by using the media encryption key to the signal processing unit 15 to subject the data to CRC processing and modulation, followed by writing the data in the assigned LBA in the falsification check region 28 inside the storage region 25 of the HAD 21.

When it is judged that the data writing is not oriented to the falsification check region by the region judging unit 19 in the hard disk controller 20, the data encrypted again by using the media encryption key are transferred to the hard disk controller 20 via the I/F control unit 111 without generating digests. Then, the hard disk controller 20 transfers the data encrypted by using the media encryption key again to the signal processing unit 15 to subject the data to CRC processing and modulation in the signal processing unit 15, followed by writing the data in the assigned LBA in the ordinary region 26 inside the storage region 25 of the HDA 21.

Since the data on the buffer RAM 22 are no longer necessary at this time, the encrypted data stored in the buffer RAM 22 and the LBA are invalidated to release the region of the buffer RAM.

Completion of the writing processing is informed to the host via the host I/F control unit 14. When an error occurs in the series of the writing process steps, the error is informed to the host via the host I/F control unit 14.

Hereinafter, the reading operation of this embodiment will now be described.

In the case of reading out data, authentication is required, too, since data on the host I/F is encrypted by using the session key. In the case where the session key is not shared, authentication is performed for sharing the session key by the host and the hard disk to set the session key and a media encryption key in the encryption processing unit 116.

In the case of the data reading, the host informs a read command to the hard disk device via the host I/F control unit 14. An LBA indicating a position of read out is also transferred as a parameter. Then, the CPU 10 judges whether or not data (data encrypted by using the media encryption key) of the assigned LBA have been cached in the buffer RAM 22 and, in the case where the data have not been cached, reads out the encrypted data of the assigned LBA from the HDA 21 by controlling the servo control unit 14 and the signal processing unit 15 to store the data in the buffer RAM 22 together with the LBA. Then, when it is judge that the LBA is an address in the falsification check region 28 by the region judging unit 19, the LBA and the encrypted data are read out from the buffer RAM 22 via the buffer memory control unit 12 to be transferred to the tamper resistant module 110 via the tamper resistant module I/F control unit 35.

The tamper resistant module 110 transfers the encrypted data to the digest generation unit 117 to generate a digest in the digest generation unit 117. The LBA is then inputted to the storage region assigning unit 119 to calculate an address of the nonvolatile memory 114 in which the digest stored when writing is stored. The digest of the address is read out from the nonvolatile memory 114. The digest read out from the nonvolatile memory 114 and the digest generate based on the data read out by the digest gentian unit 117 are inputted to the digest verification unit 118 to compare the digests in the digest verification unit 118. When the digests coincide with each other as a result of the comparison, it is judged that the data have not been falsified, and the encrypted data are transferred to the encryption processing unit 116 to decrypt the encrypted data by using the media decryption key. The decrypted data are encrypted again by using the session key to be transferred to the hard disk controller 20 via the I/F control unit 111.

In the case where a part of the data such as the contents key is stored in the nonvolatile memory 114 together with the digest as described above, the encrypted data are decrypted by using the media encryption key, and then the contents key stored in the nonvolatile memory 114 are returned to the position replaced by the dummy data, so that the decrypted data are encrypted again by using the session key to be transferred to the hard disk controller 20 via the I/F control unit 111.

The hard disk controller 20 transfers the data encrypted with the session key to the host via the host I/F control unit 14.

On the other hand, since there is a possibility of falsification when the digests do not coincide with each other as a result of the comparison, the possibility of falsification is informed to the hard disk controller 20 via the I/F control unit 111 as well as to the host via the host I/F control unit 14.

With the above-described constitution, it is possible to realize the digest generation and verification as well as the data encryption and decryption in the tamper resistant module, thereby making it possible to avoid outputting the information used for authentication, the digest generation algorithm, and the media encryption key from the tamper resistant module as well as to increase strength of security. Also, it is possible to store particularly important data with increased safety by storing a part of the data in the nonvolatile memory.

While the present invention has been described with reference to specific embodiments, those skilled in the art will appreciate that different embodiments may also be used. Thus, although the present invention has been described with respect to specific embodiments, it will be appreciated that the present invention is intended to cover all modifications and equivalents within the scope of the following claims.

What is claimed is:

1. A storage device comprising a first storage media and a controller for controlling data writing and data reading to and from the first storage media, characterized in that
the controller generates a digest of data from an external device when writing the data to the first storage media and writes the digest to a second storage media connected to or built in the controller.

2. The storage device according to claim 1, characterized in that the digest of the data is generated for each of sectors.

3. The storage device according to claim 1, characterized in that the controller gains access by relating a logical address or a physical address of the data stored in the first storage media to a logical address or a physical address of the digest stored in the second storage media.

4. The storage device according to claim 1, characterized in that
the first storage media is a hard disk, and
the second storage media is a nonvolatile memory or an IC chip.

5. A storage device comprising a first storage media and a controller for controlling data writing and data reading to and from the first storage media, characterized in that the storage device comprises:
a unit for generating a digest of data from an external device when writing the data to the first storage device;
a unit for writing the digest to a connected or built second storage media;
a unit for generating a digest of data of the first storage media when reading out the data from the first storage media;
a unit for reading out the digest from the second storage media; and
a unit for comparing, when reading out the data of the first storage device, the digest generated from the read-out data with the digest read out from the second storage media to verify whether or not the digests coincide with each other.

6. The storage device according to claim 5, characterized by further comprising a unit for authenticating an entity accessing the first storage media and by generating a digest of data to be written to the first storage media when the authentication is successful.

7. The storage device according to claim 5, characterized by further comprising:
a unit for temporarily sharing with the external device a session key for encrypting data on a transfer path;
a unit for decrypting the data that are encrypted by using the session key and transferred from the external device to be written to the first storage media; and
a unit for encrypting the data read out from the first storage media by using the session key and transferring the data to the external device.

8. The storage device according to claim 5, characterized by further comprising a unit for encrypting the data by using an encryption key unique to the storage device when writing the data to the first storage media.

9. The storage device according to claim 5, characterized by further comprising:
a unit for judging whether or not the digest is to be generated when writing data from the external device to the first storage media and
a unit for comparing, when reading out data from the first storage media, the digest generated from the read out-data with the digest read out from the second storage media to judge whether or not the verification of whether or not the digests coincide with each other is to be made.

10. The storage device according to claim 9, characterized in that the unit for judging whether or not the digest is to be generated when writing data from the external device to the first storage media and the unit for comparing, when reading out data from the first storage media, the digest generated from the read-out data with the digest read out from the connected or built second storage media to judge whether or not the verification of whether or not the digests coincide with each other is to be made make the judgments in accordance with the logical address or the physical address of the data of the first storage media.

11. The storage device according to claim 9, characterized in that the unit for judging whether or not the digest is to be generated when writing data from the external device to the first storage media and the unit for comparing, when reading out data from the first storage media, the digest generated from the read-out data with the digest read out from the second storage media to judge whether or not the verification of whether or not the digests coincide with each other is to be made make the judgments in accordance with a command from the external device.

12. The storage device according to claim 5, characterized in that the second storage media is mounted on a tamper resistant module.

13. The storage device according to claim 9, characterized in that the unit for authenticating an entity accessing the first storage media, the unit for generating a digest of data to be written to the first storage media when writing the data from the external device to the first storage media, the unit for judging whether or not the digest is to be generated when writing data from the external device to the first storage media, and the unit for comparing, when reading out data from the first storage media, the digest generated from the read-out data with the digest read out from the second storage media to judge whether or not the verification of whether or not the digests coincide with each other is to be made are implemented on a tamper resistant module.

14. The storage device according to claim 7, characterized in that the unit for temporarily sharing with the external device a session key for encrypting data on a transfer path, the unit for decrypting the data that are encrypted by using the session key and transferred from the external device to be written to the first storage media, and the unit for encrypting the data read out from the first storage media by using the session key and transferring the data to the external device are implemented on a tamper resistant module.

15. The storage device according to claim 5, characterized in that the unit for encrypting the data by using an encryption key unique to the storage device when writing the data to the first storage media is implemented on a tamper resistant module.

16. The storage device according to claim 5, characterized in that other data besides the digest are stored in the second media.

17. A controller of a storage device comprising a first storage media or connecting a first storage media and performing data writing and data reading to and from the first storage media, characterized by comprising:
a unit for generating a digest of data from an external device when writing the data to the first storage media;
a unit for writing the digest to a second storage media connected to or built in the controller;
a unit for generating a digest of data of the first storage media when reading out the data from the first storage media;
a unit for reading out the digest from the connected second storage media; and
a unit for comparing, when reading out the data of the first storage media, the digest generated from the read-out data with the digest read out from the connected second storage media to verify whether or not the digests coincide with each other.

18. A method for controlling a storage device comprising a first storage media and performing data writing and data reading to and from the first storage media, characterized by comprising:
a step for generating a digest of data from an external device when writing the data to the first storage media;
a step for writing the digest to a connected second storage media;
a step for generating a digest of data of the first storage media when reading out the data from the first storage media;
a step for reading out the digest from the second storage media; and
a step for comparing, when reading out the data of the first storage media, the digest generated from the read-out data with the digest read out from the connected second storage media to verify whether or not the digests coincide with each other.

19. The storage device control method according to claim 18, characterized by further comprising a step for authenticating an entity accessing the first storage media and by generating a digest of the read-out data when the authentication is successful.

20. The storage device control method according to claim 18, characterized by further comprising:
a step for temporarily sharing with the external device a session key for encrypting data on a transfer path;
a step for decrypting the data that are encrypted by using the session key and transferred from the external device to be written to the first storage media; and
a step for encrypting the data read out from the first storage media by using the session key and transferring the data to the external device.

21. The storage device control method according to claim 18, characterized by further comprising a step for encrypting the data by using an encryption key unique to the storage device when writing the data to the first storage media.
